(19) United States
(12) Patent Application Publication
(10) Pub. No.: US 2010/0095914 A1
(43) Pub. Date: Apr. 22, 2010

(54) EXTERNAL COMPRESSION TWO-STROKE INTERNAL COMBUSTION ENGINE

(76) Inventor: Lincoln Evans-Beauchamp, Palo Alto, CA (US)

Correspondence Address: CARR & FERRELL LLP, 2200 GENG ROAD, PALO ALTO, CA, 94303, US

(21) Appl. No.: 12/252,779

(22) Filed: Oct. 16, 2008

(51) Int. Cl. F02B 33/00

(52) U.S. Cl. 123/68

(57) ABSTRACT

A system and method is described for an internal combustion engine. The system comprises a compressor configured increase a pressure and temperature of a gas to produce a compressed gas and to maintain a continuous pressure and temperature of the compressed gas at more than four times ambient pressure and greater than a combustion temperature of a fuel and an internal combustion engine. The internal combustion engine includes a cylinder configured to receive the compressed gas from the compressor at the increased pressure and temperature, a piston disposed in the cylinder, and an intake valve disposed between the compressor and the cylinder, the intake valve configured to open based on a position of the piston for admitting the compressed gas into the cylinder. The system further includes a fuel source configured to provide the fuel to the cylinder.

### CROSS-REFERENCE TO RELATED APPLICATIONS

### BACKGROUND OF THE INVENTION

1. Field of the Invention

The present invention relates to internal combustion engines.

2. Description of Related Art

An embodiment of an internal combustion engine includes a cylinder, a piston, a crankshaft, a cylinder head (head), an intake valve and an exhaust valve. A position of the piston is generally referred to with reference to top dead center and/or bottom dead center. Top dead center occurs when the crankshaft extends the piston to a point closest to the head. At top dead center there is minimum volume in the cylinder between the piston and the head. Bottom dead center occurs when the crankshaft moves the piston to a maximum distance from the head. At bottom dead center there is maximum volume in the cylinder between the piston and the head. As the crankshaft rotates, the piston position may be described in terms of degrees (of the crankshaft) before or after top dead center. The phrase “after top dead center” means the piston is moving away from the head when the engine is rotating in a forward direction. Similarly, “before top dead center” means the piston is moving toward the head. For example, ten degrees before top dead center describes the piston as moving toward the head and an angle of ten degrees between the crankshaft and the position of the crankshaft when the piston is at top dead center. Similarly fifteen degrees after top dead center refers to the piston moving away from the head and an angle of fifteen degrees. Thus, at 90 degrees after top dead center, the piston would be moving away from the head and at a position halfway between the minimum travel and maximum travel from the head. Similarly, at 60 degrees before top dead center (120 degrees after bottom dead center), the piston would be moving toward the head and at a position one quarter of the way between from minimum distance to maximum distance from the head. The volume of the cylinder would be about one quarter of the maximum volume. If the engine rotates in a reverse direction, the piston moves away from the head before top dead center and toward the head before top dead center.

An internal combustion engine includes a compression stroke, a combustion stroke, an exhaust stroke and in intake stroke. During the intake stroke, the piston draws an air/fuel mixture through the intake valve into the cylinder between top dead center (or a few degrees after top dead center) and bottom dead center. Upon reaching bottom dead center, the piston begins the compression stroke. The intake and exhaust valves are both closed as the piston moves from bottom dead center towards top dead center compression the air/fuel mixture between the piston and the head. At top dead center, the volume of the cylinder is minimum and the air/fuel mixture reaches maximum compression. Thus, compression is performed by the piston inside the cylinder. In a gasoline engine, a spark plug may ignite the fuel/air mixture at top dead center or a few degrees before or after top dead center to initiate combustion. In a diesel engine, the compression may increase the temperature of the fuel/air mixture adiabatically to an auto combustion temperature. Auto combustion temperature is a temperature at which a fuel/air mixture can combust spontaneously at a particular pressure. Combustion is accomplished in a compression-ignition or fuel-injected engine by injecting fuel into the cylinder when the cylinder is a few degrees before top dead center. Combustion of the fuel/air mixture produces a combustion gas that drives the piston away from the head through the combustion stroke from top dead center to bottom dead center. As the fuel burns volume of the cylinder increases, the combustion gas expands to become exhaust gas. At about bottom dead center the exhaust valve opens to release the exhaust gas. During the exhaust stroke, the piston moves from bottom dead center toward the head pushing out the exhaust gas through the exhaust valve. Upon reaching top dead center most or all of the exhaust gas has been removed and the next intake stroke begins. The intake stroke draws in fresh air and fuel is injected into the cylinder a few degrees before or after top dead center using a fuel injector. Fuel for internal combustion engines includes gasoline, diesel, alcohol, a blend of gasoline and alcohol, and/or diesel and natural gas.

### SUMMARY OF THE INVENTION

Various embodiments include a system comprising a compressor configured increase a pressure and temperature of a gas to produce a compressed gas and to maintain a continuous pressure and temperature of the compressed gas at, for example, more than four times ambient pressure and greater than a combustion temperature of a fuel. The internal combustion engine includes a cylinder configured to receive the compressed gas from the compressor at the increased pressure and temperature, a piston disposed in the cylinder, and an intake valve disposed between the compressor and the cylinder. The intake valve can be configured to open based on a position of the piston for admitting the compressed gas into the cylinder. The fuel source can be configured to provide the fuel to the cylinder.

Various embodiments include a method comprising compressing a gas outside of an internal combustion engine, maintaining a pressure of the compressed gas continuously at, for example, greater than four times ambient pressure during, for example, more than four strokes of the internal combustion engine. Next, the compressed gas is provided to a cylinder of the internal combustion engine after a piston in the cylinder passes top dead center during a power stroke and a fuel is provided to the cylinder before the piston reaches bottom dead center during the power stroke. A combustion product is produced in the cylinder from the compressed gas and the fuel during the power stroke. Next the piston is driven in the cylinder using the combustion product during the power stroke and an exhaust gas is released from the cylinder during an exhaust stroke immediately following the power stroke. The compressed gas is provided to the cylinder of the internal combustion after the piston passes top dead center during a power stroke immediately following the exhaust stroke.

Various embodiments include a method comprising opening an intake valve of a cylinder of an internal combustion engine and receiving a compressed gas having a temperature of a fuel combustion temperature. The compressed gas is received through the open the intake valve from outside of the internal combustion engine. The intake valve is closed after a piston in the cylinder passes top dead center of a power stroke and fuel received before the piston reaches bottom dead center of the power stroke. Combustion gas is produce in the cylinder from the compressed gas and the fuel before the piston reaches bottom dead center of the power stroke. The combustion gas drives the piston in the cylinder toward bottom dead center. The exhaust valve is opened and the piston pushes exhaust gas out of the cylinder through the open exhaust valve during an exhaust stroke immediately following the power stroke. The exhaust valve may be closed before reaching top dead center of the exhaust stroke.

### BRIEF DESCRIPTION OF THE DRAWINGS

FIG. 1 is a block diagram illustrating an internal combustion engine and external compressor an in accordance with various aspects of the current technology.

FIGS. 2A-2D are block diagrams illustrating details of operation of the internal combustion engine of FIG. 1.

FIG. 3 is a cycle diagram illustrating various phases of the internal combustion engine of FIG. 1 and the block diagrams of FIGS. 2A-2E in accordance with aspects of the technology.

FIG. 4 is a cycle diagram illustrating various alternative phases of an embodiment of the internal combustion engine of FIG. 1 and the block diagrams of FIGS. 2A-2E in accordance with aspects of the technology.

FIG. 5 is a cycle diagram illustrating various alternative phases of an embodiment of the internal combustion engine of FIG. 1 and the block diagrams of FIGS. 2A-2E in accordance with aspects of the technology.

FIG. 6 is a cycle diagram illustrating various alternative phases of an embodiment of the internal combustion engine of FIG. 1 and the block diagrams of FIGS. 2A-2E in accordance with aspects of the technology.

FIG. 7 is a cycle diagram illustrating various phases of an embodiment of the internal combustion engine of FIG. 1 operating in a reverse direction in accordance with aspects of the technology.

FIG. 8 is a block diagram illustrating an alternative embodiment of the internal combustion engine of FIG. 1.

FIG. 9 is block diagram illustrating an alternative embodiment of the internal combustion engine of FIG. 8.

FIG. 10 is a flow diagram of an exemplary process for operating an internal combustion engine, according to various embodiments of the technology.

FIG. 11 is a flow diagram of an exemplary process for operating an internal combustion engine, according to various embodiments of the technology.

### DETAILED DESCRIPTION

Various embodiments of the invention include operating an internal combustion engine without a compression stroke and using an external compressor to provide compressed air to a cylinder of the inter combustion engine instead of using a piston in the cylinder to compress the air. For example, a diesel piston engine configured to operate without a compression stroke may be coupled an external compressor. The external compressor may provide compressed air to the diesel engine at or above a spontaneous combustion or auto ignition temperature of a fuel. A cylinder of the diesel engine may receive the compressed air at top dead center and the fuel may be injected into a cylinder to mix with the compressed air and form a combustion product or combustion gas. The combustion gas may drive the piston to bottom dead center to complete a power stroke. After bottom dead center, exhaust gas may be pushed out of the cylinder by the piston as it returns to top dead center to complete an exhaust stroke. At top dead center, the cylinder may receive the next charge of compressed air from the compressor and an injection of fuel to initiate the next power stroke, and so on. Thus, a diesel engine may be operated in a two stroke mode. Likewise, a gasoline engine may be operated in a two stroke mode using an external compressor to provide air at or above a sustained combustion temperature but below a spontaneous combustion temperature and using a spark plug to initiate combustion.

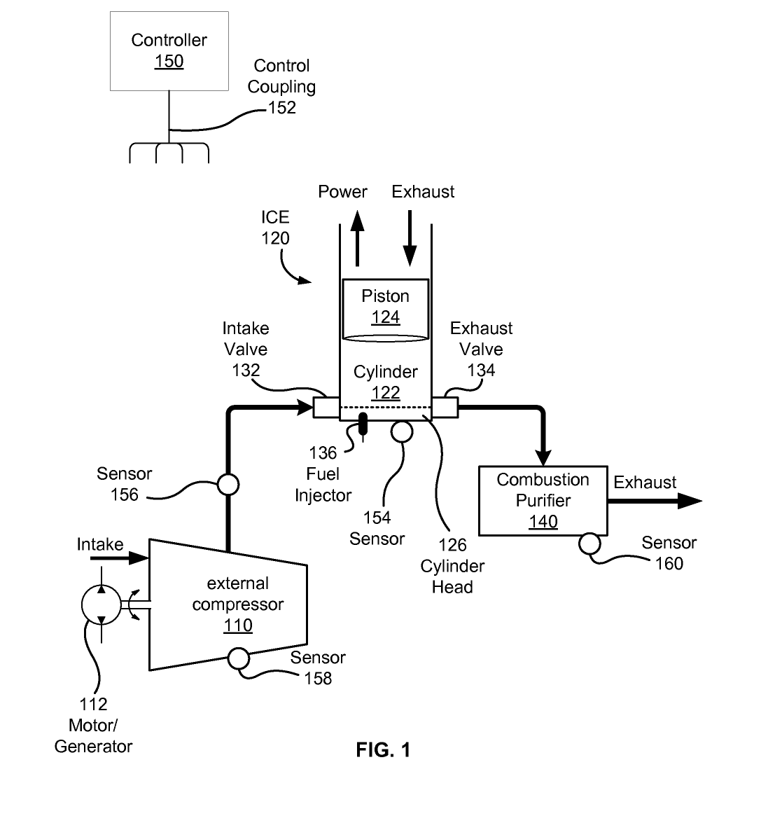

FIG. 1 is a block diagram illustrating an inter combustion engine 120 and external compressor 110 in accordance with various aspects of the current technology. The inter combustion engine includes a cylinder 122, a piston 124 and a cylinder head 126. The internal combustion engine 120 further includes an intake valve 132, an exhaust valve 134, an optional fuel injector 136, and optional sensor 154. While the intake valve 132 and exhaust valve 134 are illustrated as disposed in a wall of the cylinder 122, they may be disposed in the cylinder head 126, a manifold, or other location. While the fuel injector 136 and sensor 154 are illustrated as disposed in the cylinder head 126, they may be disposed in a wall of the piston 124, a manifold, or other location.

The external compressor 110 is configured to receive air at ambient pressure and provide compressed air or gas to the cylinder 122. In some embodiments, a gas other than air may be compressed by the external compressor 110 and provided as a compressed gas to the cylinder 122. The compressor 110 is configured to compress the air to some pressure greater than ambient pressure, for example, 4, 8, 10, 12, 16, 17, 18, 20, 25, 30 or greater, times ambient pressure (e.g., atmospheres). The compressed air is also heated, e.g., adiabatically, to a substantial percentage of a combustion temperature during the compression. At about 8 times ambient pressure, the temperature of the compressed gas may be about the auto ignition temper of various fuels, e.g., diesel. Optionally, the external compressor 110 may heat the air to a temperature above the auto ignition for a fuel, a temperature below the auto ignition and above a combustion temperature for the fuel, or a temperature below the combustion temperature for the fuel.

The intake valve 132 may admit the compressed gas from the external compressor 110 to the cylinder 122 during a power stroke. The fuel injector 136 is configured to inject fuel into the cylinder 122 also during the power stroke. Alternatively, some other fuel source may provide fuel to the cylinder 122 during the power source. The injected fuel may mix with the compressed gas to form a combustion gas in the cylinder 122 and drive a piston 124 during the power stroke. An exhaust valve 134 may be opened and release exhaust gas from the cylinder 122 during an exhaust stroke. In some embodiments, fuel may be mixed with the compressed gas before introduction to the cylinder 122 and combustion may be initiated, e.g., using a spark or a glow plug.

The power stroke, when the internal combustion engine is rotating in a forward direction, includes a portion of the internal combustion engine cycle when the piston is after top dead center and before bottom dead center and is moving away from the cylinder head 126. The exhaust stroke, when the internal combustion engine is rotating in the forward direction, may be defined as a portion of the internal combustion engine cycle when the piston is after bottom dead center and before top dead center and is moving toward from the cylinder head 126.

Conversely, the power stroke, when the internal combustion engine is rotating in a reverse direction, is a portion of the internal combustion engine cycle when the piston is before top dead center and after bottom dead center and is moving away from the cylinder head 126. The exhaust stroke, when the internal combustion engine is rotating in the reverse direction, is a portion of the internal combustion engine cycle when the piston is before bottom dead center and after top dead center and is moving toward the cylinder head 126.

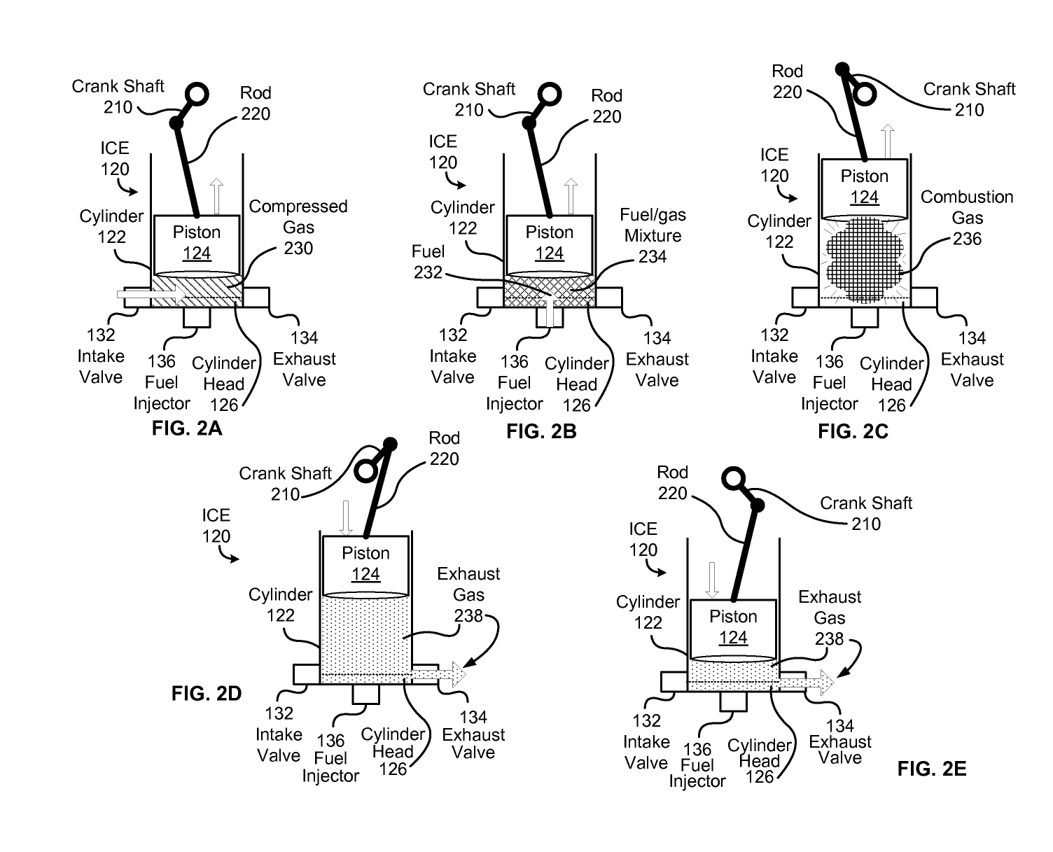

FIGS. 2A-2D are block diagrams illustrating details of operation of the internal combustion engine 120 of FIG. 1. A rod 220 connects the piston 124 to a crankshaft 210. A forward rotation of the internal combustion engine 120 is represented by a clockwise rotation of the crankshaft 210. A reverse rotation of the internal combustion engine 120 is represented by a counter-clockwise rotation of the crankshaft 210. The terms “before top dead center” and “after top dead center” are used in reference to an absolute angle of the crankshaft 210 with respect to top dead center rather than a direction of rotation of the crankshaft 210.

In FIG. 2A, the piston 124 is a few degrees after top dead center, shortly after beginning the power stroke. The intake valve 132 has been opened to admit compressed gas 230 at about auto ignition temperature into the cylinder 122. The intake valve 132 may be opened during the power stroke, i.e., after top dead center. Alternatively, the intake valve 132 may have been opened at or before top dead center. When the piston 124 is at a position in the power stroke selected for a desired power, the intake valve 132 may be closed. The amount of compressed gas 230 in the cylinder 122 and, thus, the potential power and torque may depend on the position of the piston 124 when the intake valve 132 is closed.

In FIG. 2B, the piston 124 is a few degrees after top dead center, shortly after beginning the power stroke. The intake valve 132 has been closed and fuel 232 is injected into the cylinder 122, e.g., using the fuel injector 136. The fuel 232 rapidly mixes with the compressed gas to form a fuel/gas mixture 234 (or fuel/air mixture). The fuel/gas mixture 234 depends on an amount of fuel 232 injected and the volume of the cylinder 124 when the intake valve is closed. The amount of fuel 232 injected may be metered through the fuel injector 136 and may be based on the position of the piston 124 when the intake valve 132 is closed. Thus, a lean, rich, or optimum fuel/gas mixture 234 may be achieved as desired. If the temperature of the compressed gas 230 is at or above auto ignition temperature, combustion occurs spontaneously as the fuel 232 enters the cylinder 122 producing a combustion gas 236. Alternatively, when the temperature of the compressed gas 230 is below auto ignition temperature but above combustion temperature, combustion of the fuel 232 may be initiated using a spark. Fuel 232 may be injected under a higher pressure than a pressure of the combustion gas 236 (combustion pressure) in the cylinder 122. Typically, the fuel 232 is injected at a pressure many times the combustion pressure, e.g., at approximately 3,000 pounds per square inch (psi) or about 200 atmospheres. Typically, a combustion pressure is about 17 atmospheres. Thus, the fuel 232 mixes rapidly with the compressed gas 230 and the combustion pressure does not blow the fuel 232 back out the fuel injector 136.

In FIG. 2C, the piston 124 is illustrated a few degrees before bottom dead center, almost to the end of the compression stroke. The combustion gas 236 has driven the piston 124 through a portion of the power stroke and away from the cylinder head 126. The intake valve 132 and the exhaust valve 134 are both closed. The pressure of the combustion gas 236 has decreased as the piston 124 has moved away from the cylinder head 126 and the volume of the cylinder has increased. In some embodiments, the exhaust valve 134 may be opened when the pressure of the combustion gas 236 has decreased to about the same pressure as the compressed gas 230. This may occur before the piston 124 reaches bottom dead center. Optionally, the exhaust valve 134 opens when the pressure of the combustion gas 236 is about ambient pressure. In some embodiments, the exhaust valve 134 is configured to open when the piston 124 reaches the end of the power stroke and is at bottom dead center.

In FIG. 2D, the piston 124 is illustrated at a few degrees after bottom dead center and after beginning the exhaust stroke. The exhaust valve 134 is open and an exhaust gas 238 is exhaust gas is being pushed out of the cylinder 122 using the piston 124. In some embodiments, the exhaust gas 238 is discharged from the cylinder 122 at about the same pressure as the compressed gas 230, e.g., to another portion of the internal combustion engine 120. Alternatively, the exhaust gas 238 is discharged at about ambient pressure instead of the pressure of the compressed gas 230 to ambient air.

In FIG. 2E, the piston 124 is a few degrees before top dead center and most of the exhaust gas 238 has been expelled from the cylinder 122. The exhaust valve 134 may be closed when the piston 124 reaches top dead center. The next power stroke may begin immediately after the exhaust stroke as illustrated beginning with FIG. 2A. Optionally, the intake valve 132 is opened before top dead center while the exhaust valve 134 is still open. The compressed gas 230 may flow through the cylinder head 126 and purge the exhaust gas 238. The intake valve 132 and exhaust valve 134 may remain open until after top dead center and into an initial portion of the power stroke. In some embodiments, the exhaust valve 134 is closed and the intake valve 132 is opened before top dead center. Then, after the compressed gas 230 enters the cylinder 122, the intake valve 132 may be closed while the piston 124 is still before top dead center. Thus, the compressed gas 230 may be further compressed.

In some embodiments, the fuel 232 is mixed with the compressed gas 230 externally to the cylinder 122, instead of being injected using the fuel injector 136. The compressed gas 230 may be at a temperature below auto ignition and combustion may be initiated using a spark. Fuels for which this may be useful include gasoline, hydrogen, liquefied petroleum gas, liquefied natural gas, natural gas, ethanol, methanol, propanol, methane, propane, butane, paraffin, coal dust, saw dust, rice dust, flour, grain dust, cellulose dust, alcohol, a blend of gasoline and alcohol, natural gas, methane, propane, butane, liquefied natural gas, hydrogen, and/or the like. Additional fuels include cellulose products, forms of carbon, hydrocarbon, waste chemicals and materials (garbage, paint, hazardous waste, chemical waste, tires) biological products and materials. Compounds that release energy (exothermic reaction) whenever combined with another chemical (e.g., Oxygen) may be used as fuels. The fuels and compounds may be finely ground into particulates and/or dust. In some embodiments, particulates and/or dust may be mixed into a slurry or suspended in a combustible fluid.

An optional motor/generator 112 may be configured to drive the external compressor 110. In various embodiments, the external compressor 110 may be driven using electric motors, gasoline engines, diesel engines, turbines, wind generators, solar generators, fuel cells and/or the like. Energy for driving the external compressor 110 may be stored in batteries, the grid, flywheels, fuel cells, etc. The external compressor 110 may intake ambient air, compress the air and heat the compressed air (e.g., adiabatically) to a temperature at or above a spontaneous combustion temperature of the fuel. In some embodiments, a heater may be disposed in the compressor 110 or inline with the compressor and configured to heat the air. In various embodiments, the external compressor 110 includes root gear pumps, screw pumps, reciprocating compressors, rotary compressors, centrifugal compressors, axial compressors, mixed compressors, and radial flow compressors, and the combinations thereof. In some embodiments, the external compressor 110 is one stage of a multi stage compressor system configured to intake pre-compressed air.

Referring back to FIG. 1, an optional combustion purifier 140 may remove particulates from the exhaust gas 238. The combustion purifier 140 is configured to heat the exhaust gas 238 to a combustion temperature of particulates in the exhaust gas 238 and remove the particulates from the exhaust gas 238. Examples of the combustion purifiers are set forth in further detail in co-pending U.S. patent application Ser. No. 11/404,424, filed Apr. 14, 2006, titled “Particle burning in an exhaust system,” U.S. patent application Ser. No. 11/412,481, filed Apr. 26, 2006, titled “REVERSE FLOW HEAT EXCHANGER FOR EXHAUST SYSTEMS,” U.S. patent application Ser. No. 11/412,289, filed Apr. 26, 2006, titled “Air purification system employing particle burning,” U.S. patent application Ser. No. 11/787,851, filed Apr. 17, 2007, titled “Particle burner including a catalyst booster for exhaust systems,” and U.S. patent application Ser. No. 11/800,110, filed May 3, 2007 titled “Particle burner disposed between an engine and a turbo charger.” All of the above applications are incorporated by reference herein in their entirety.

A controller 150 may be coupled to valves and sensors via a control coupling 152. The controller 150 may be coupled to the intake valve 132 and the exhaust valve 134 and configured to control opening and closing of these valves. The controller 150 may be coupled to the fuel injector 136 and configured to control timing of the fuel injector 136. In some embodiments, the controller 150 is coupled to the compressor 110, the motor generator 112, and/or the combustion purifier 140. The controller 150 may control an output pressure of the compressor 110 and an RPM of the motor generator 112. The controller 150 may control a temperature in the combustion purifier 140.

The controller may be coupled to sensors 154, 156, 158 and/or 160. The sensor 154 includes one or more sensors configured to sense various parameters in the internal combustion engine 120 including a position of the piston 124, a velocity of the piston 124, rotations per minute (RPM) of the crankshaft 210, a pressure within the cylinder 122, a temperature within the cylinder 122, and/or the like. The sensor 156 includes one or more sensors configured to sense various parameters of the compressed gas 230 including a pressure, temperature, volume, flow, velocity, and/or the like. The sensor 158 includes one or more sensors configured to sense various parameters of the external compressor 110 including an RPM temperature, pressure, volume, flow, and/or the like. The sensor 160 includes one or more sensors configured to sense various parameters of the exhaust gas 238 and/or combustion purifier 140 including a pressure, temperature, volume, flow, velocity, and/or the like. While four sensors, namely sensor 154, 156, 158 and 160 are illustrated in FIG. 1, more or fewer sensors may be used. For example, sensors may be disposed on one or more of the valves and configured to sense a state of the valves. The controller 150 is configured control a timing of the intake valve 132, the fuel injector 136, the exhaust valve 134, external compressor 110, or a combination thereof based data received from the sensors 154, 156, 158 and/or 160.

In various embodiments, the control coupling 152 includes a cam shaft and valve train, a wiring harness, relays, circuit boards, processors, optical transmission devices, optical cable, wireless transmitter, wireless receivers, electrical valve actuators, a hydraulic system, and/or the like. In various embodiments, the controller 150 includes a computer system, a memory, a processor, a computer interface, a cam shaft, a timing belt, a distributor, and/or a combination thereof. In some embodiments, the controller 150 includes a plurality of computer systems, processors, and/or interfaces. For example, a first processor in the controller 150 may be configured to control valves and injectors (e.g., valve 132, valve 134, and fuel injector 136) while a second processor in the controller 150 is configured to control the compressor 110 and a third processor is configured to receive data from sensors (e.g., sensors 154, 156, 158, and 160) and communicates the data to the first and/or second processor.

While one cylinder is illustrated in FIG. 1, a person having ordinary skill in the art will appreciate that more than one cylinder may be used. The cylinders may be configured to drive one or more crankshafts. For example, an internal combustion engine including 2, 3, 4, 6, 8, 10, 12, 14, 16, 18, or more cylinders 122 may be used in the manner described elsewhere with respect to internal combustion engine 120 and cylinder 122.

In operation, a power produced by the internal combustion engine 120 during the power stroke may be adjusted by selecting a position of the piston 124 for closing the intake valve 132. A total energy of the power stroke depends on an amount of compressed gas 230 in the cylinder 122 available for burning the fuel 232 and an amount of fuel 232 mixed with the compressed gas. The amount of compressed gas 230 in the cylinder 122 in turn depends on the position of the piston 124 when the intake valve 132 closes. The longer after top dead center the intake valve 132 closes, the more compressed gas 230 is admitted to the cylinder 122 for burning with the fuel 232. An amount of fuel 232 may be selected using the fuel injector 136 for a desired fuel/air mixture of the compressed gas 230 and fuel 232. Thus, a constant fuel/air mixture may be maintained for any amount of compressed gas 230 in the cylinder. At a constant fuel/air mixture, the farther after top dead center the intake valve 132 closes the more power and the closer to top dead center the intake valve 132 is closed the less power. The fuel air mixture may be further optimized for each position of the piston 124 at which the intake valve is closed. In some embodiments, an amount of fuel 232 less than optimum may be injected into the cylinder for running the internal combustion engine 120 in a lean condition. Alternatively, an amount of fuel 232 greater than optimum may be injected into the cylinder for running the internal combustion engine 120 in a rich condition, e.g., for cooling the cylinder and piston.

While the internal combustion engine 120 may be operated above 40 RPM, it may also be operated below 40 RPM. For example, by selecting the timing of the intake valve 132 and exhaust valve 134 and an amount of fuel injected by the fuel injector 136, the internal combustion engine 120 may be operated over a range of RPM below 40 RPM without stalling the internal combustion engine 120. In various embodiments, the internal combustion engine 120 may be operated at or below 30, 20, 10, 5, 2, 1 RPM, or near zero RPM or even at zero RPM. By selecting a timing and sequence of the intake valve, the exhaust valve 134, and the fuel injector 136, the internal combustion engine 120 may be operated to rotate in a reverse direction. Thus, the internal combustion engine 120 may be operated through a continuous range of RPM from greater than 40 RPM to less than 40 RPM, and from 40 RPM down through zero RPM to a negative RPM or reverse rotation.

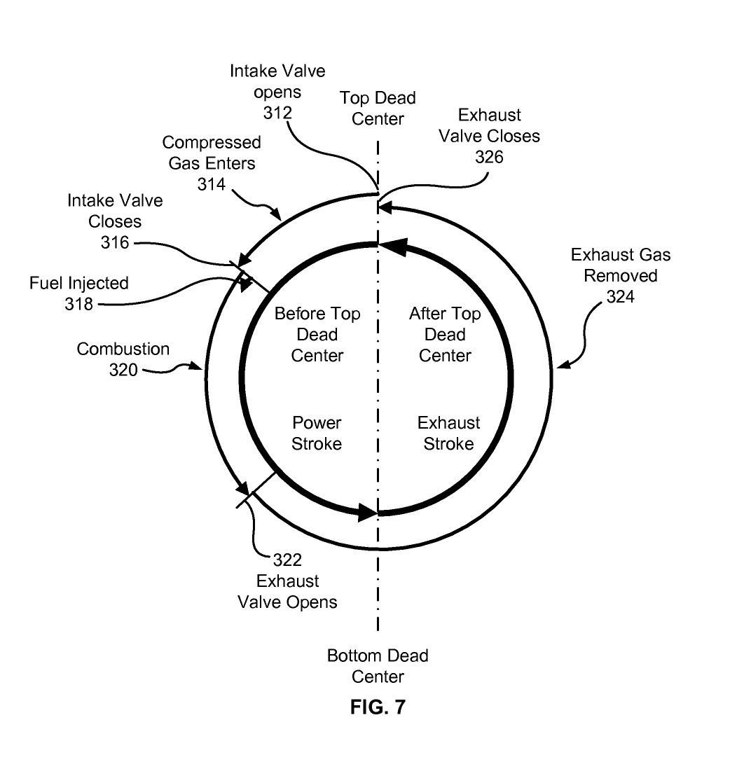

When the internal combustion engine 120 is running at a slow RPM or stopped, it may be reversed. It will be apparent to a person having ordinary skill in the art that a forward or reverse rotation of the internal combustion engine 120 depends only on a timing and sequence of opening and closing the intake valve 132, the exhaust valve 134 and the fuel injector 136. For example, when the piston 124 of cylinder 122 is at a position before top dead center, the intake valve 132 may be open to charge the cylinder with compressed gas 230 and the exhaust valve 134 may be closed. Upon charging the cylinder 122 with compressed gas 230, the intake valve 132 is closed and the fuel injector 136 injects fuel 232 into the cylinder 122. The resultant combustion gas 236 will drive the piston 124 toward bottom dead center while rotating the crankshaft 210 in a counter-clockwise (reverse) direction. At bottom dead center, the exhaust valve may be opened to release the exhaust gas 238 as the crankshaft continues rotating counter clockwise. As the piston 124 moves from bottom dead center to top dead center the exhaust gas 238 is pushed out by the piston 124. At top dead center the intake valve 132 may be opened and the exhaust valve 134 may be closed and the cycle repeated. (See for example, FIG. 7 described in more detail elsewhere herein) Thus, when the internal combustion engine 120 is rotating at a slow RPM or stopped the timing of valves 132 and 134 may be selected to drive the piston 124 and crankshaft in a reverse direction. Indeed, in some embodiments, reverse or forward rotation of the internal combustion engine 120 is merely a matter of convention since the internal combustion engine 120 may be operated in either direction equally well.

It will be apparent to a person having ordinary skill in the art that an internal combustion engine 120 including multiple cylinders 122 may be started from a stop without a clutch. For example, a cylinder 122 in which any one of the pistons 124 is in a position after top dead center may be charged with compressed gas 230 and injected with fuel 232 to begin combustion resulting in rotation of the crankshaft 210 in a forward direction. Other cylinders 122 may in turn be charged with compressed gas 230 and injected with fuel 232 in an appropriate sequence and at an appropriate position to continue driving the forward rotation. Thus, a vehicle powered by the internal combustion engine 120 may be driven to a stop (e.g., at a signal light) by progressively reducing the RPM to zero and then restarted by selecting an appropriate cylinder 122 for combustion. Similarly, a cylinder 122 in which the piston 124 is in a position before top dead center may be selected and charged with compressed gas 230 and injected with fuel 232 to begin combustion resulting in rotation of the crankshaft 210 in a reverse direction. Other cylinders 122 may in turn be charged with compressed gas 230 and injected with fuel 232 in an appropriate sequence and at appropriate positions to continue driving the reverse rotation. Another example includes an internal combustion engine 120 having multiple cylinders 122 and configured to drive a propeller in a ship. The propeller may be operated at full speed in a forward direction, slowed to a stop, reversed, accelerated in a reverse direction and operated at full speed in a reverse using a selection of timing and sequence of the valves and injectors.

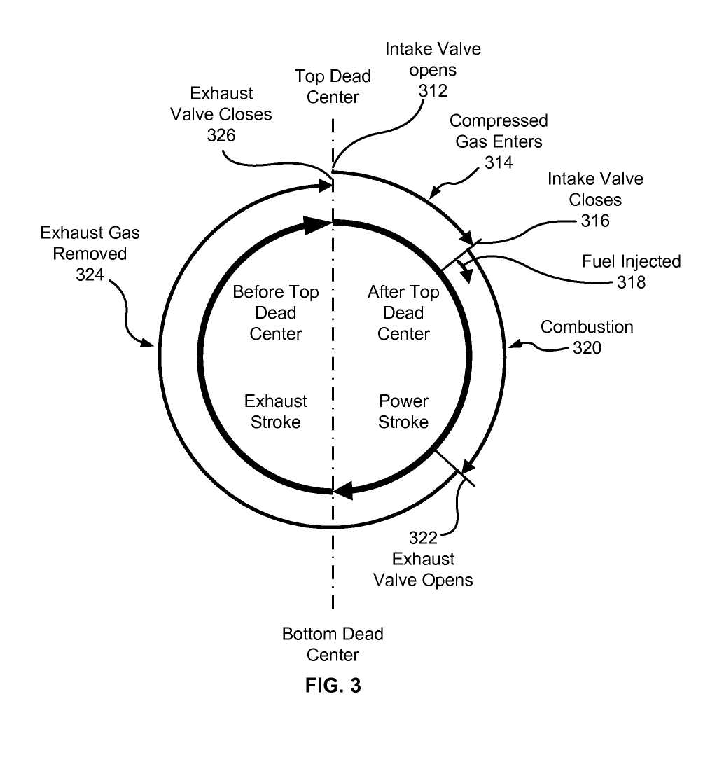

FIG. 3 is a cycle diagram illustrating various phases of the internal combustion engine 120 of FIG. 1 and the block diagrams of FIGS. 2A-2E in accordance with aspects of the technology. The forward direction in FIG. 3 is clockwise around the cycle diagram. The power stroke is illustrated as a period after top dead center beginning at top dead center and ending at bottom dead center. The exhaust stroke is illustrated as a period before top dead center beginning at bottom dead center and ending at top dead center. Before top dead center and after top dead center refer to absolute angles of a crankshaft, e.g., the crankshaft 210, with respect to top dead center. Starting at top dead center the intake valve 132 opens at time 312. While time 312 is illustrated as occurring at top dead center, it may occur a few degrees before or after top dead center. Period 314 is a period during which the intake valve 132 is open. The compressed gas 230 enters the cylinder 122 during period 314. The intake valve 132 closes at time 316. The fuel 232 is injected at time 318. While time 318 is illustrated as beginning immediately after the intake valve closes at time 316, there may be a delay between time 316 and time 318. The duration of injection of fuel at time 318 may be adjusted to provide a desired fuel/air mixture 234. A combustion period 320 begins upon injection of the fuel 232 and drives the piston 124 through a portion of the power stroke. At time 322, the exhaust valve 134 opens to begin removal of the exhaust gas 238. While time 322 is illustrated as occurring before bottom dead center, the exhaust valve 134 may open at bottom dead center or even after bottom dead center. Period 324 is a period during which the exhaust valve 134 is open. The exhaust gas 238 is released from the cylinder 122 through the exhaust valve 134 during period 324. From bottom dead center until the end of period 324, the piston 124 pushes the exhaust gas out of the cylinder 122. At time 326 the exhaust valve closes ending the period 324. The cycle then begins again with the opening of the intake valve 132 at time 312. While time 326 is illustrated as occurring at top dead center, it may occur a few degrees before or after top dead center.

A pressure of the compressed gas 230 in the cylinder 122 upon intake may be referred to as intake pressure. A peak pressure of the combustion gas 236 may be referred to as combustion pressure. A pressure to which the exhaust gas 238 is vented may be referred to as exhaust pressure. In some embodiments, the exhaust pressure may be selected to be about the same as the intake pressure. For example, if the intake pressure is about 9 times ambient, and the combustion pressure is about 18 times ambient the exhaust valve 134 may be opened when the volume of the cylinder 122 is about two times what the volume of the cylinder was at the time the intake valve 132 was closed. Thus, (neglecting volume of the cylinder head 126 for simplicity), if the intake valve is closed at 60 degrees after top dead center, the exhaust valve may be opened at about 120 degrees after top dead center (or 60 degrees before top dead center). Similarly, if the intake valve is closed at 90 degrees after top dead center, the exhaust valve may be opened at about bottom dead center. Similar calculations may be performed for when the exhaust pressure is selected to be ambient. For example, when the intake pressure is about 8 times ambient and the combustion pressure is about 17 times ambient, (again neglecting the cylinder head volume), if the intake valve 132 is closed at about 28 degrees after top dead center, the exhaust valve may be opened at about bottom dead center. Similarly, if the intake valve 132 is closed at about 25 degrees after top dead center, the exhaust valve may be opened at about 126 degrees after top dead center or about 54 degrees before bottom dead center.

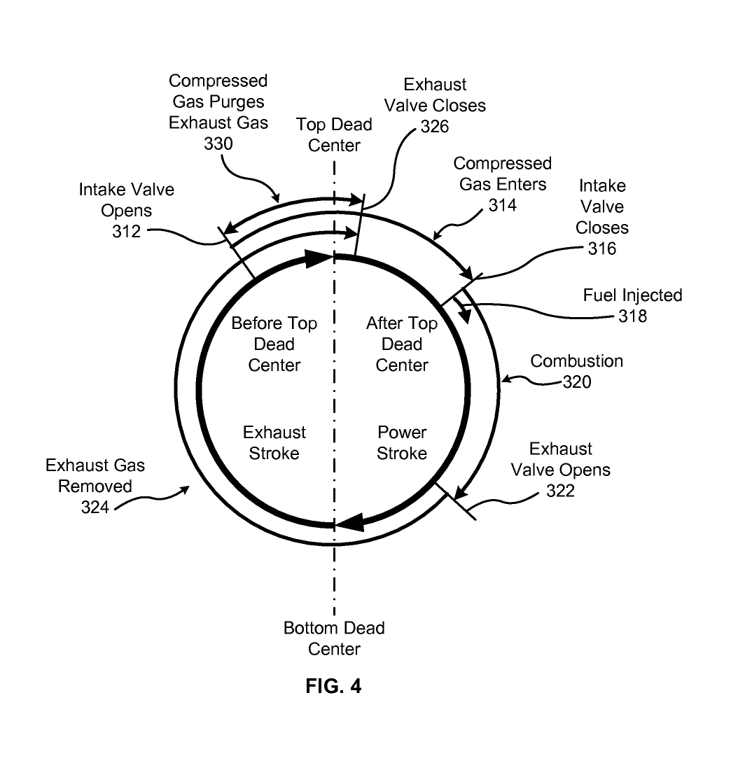

FIG. 4 is a cycle diagram illustrating various alternative phases of an embodiment of the internal combustion engine 120 of FIG. 1 and the block diagrams of FIG. 2A-2E in accordance with aspects of the technology. FIG. 4 differs from FIG. 3 in that time 312 for the intake valve 132 to open occurs before top dead center and before time 326 for the exhaust valve 134 to close. This results in a time period 330 during which both the intake valve 132 and the exhaust valve 134 are open. During time period 330, the compressed gas 230 purges the exhaust gas from the cylinder. While time 326 is illustrated as occurring after top dead center, the exhaust valve may close at or before top dead center. In some embodiments, at top dead center, the volume of the cylinder is minimum and purging using the compressed gas 230 would be most effective.

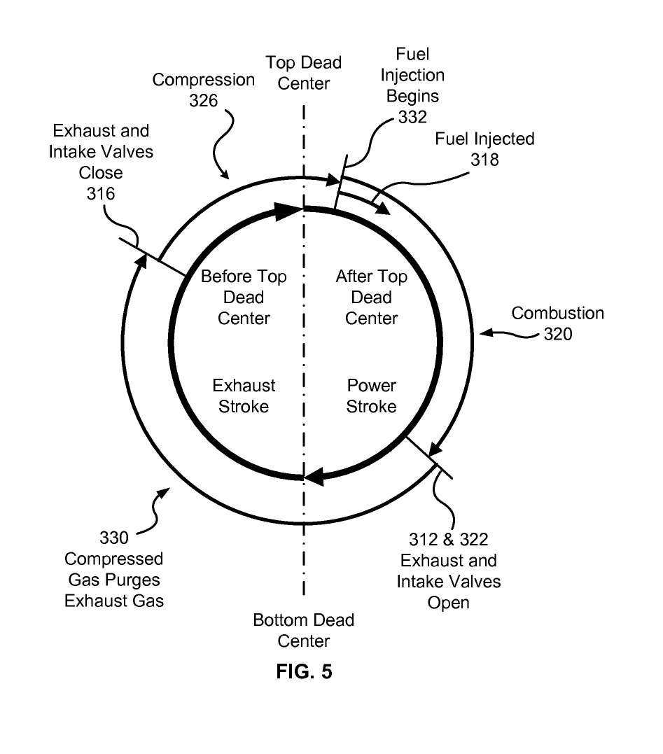

FIG. 5 is a cycle diagram illustrating various alternative phases of an embodiment of the internal combustion engine 120 of FIG. 1 and the block diagrams of FIG. 2A-2E in accordance with aspects of the technology. FIG. 5 differs from FIG. 4 in that time 312 time 322 both occur at the same time. That is, both the intake valve 132 and the exhaust valve 134 are opened at the same time. Thus, the period for the compressed gas 230 begins when the exhaust valve opens at time 322. FIG. 5 further differs from FIG. 4 in that time 316 for the intake valve 132 to close occurs before top dead center. Thus, the compressed gas 230 is further compressed. Fuel injection begins at time 332. While time 332 is illustrated as occurring after top dead center, fuel may be injected at or before top dead center.

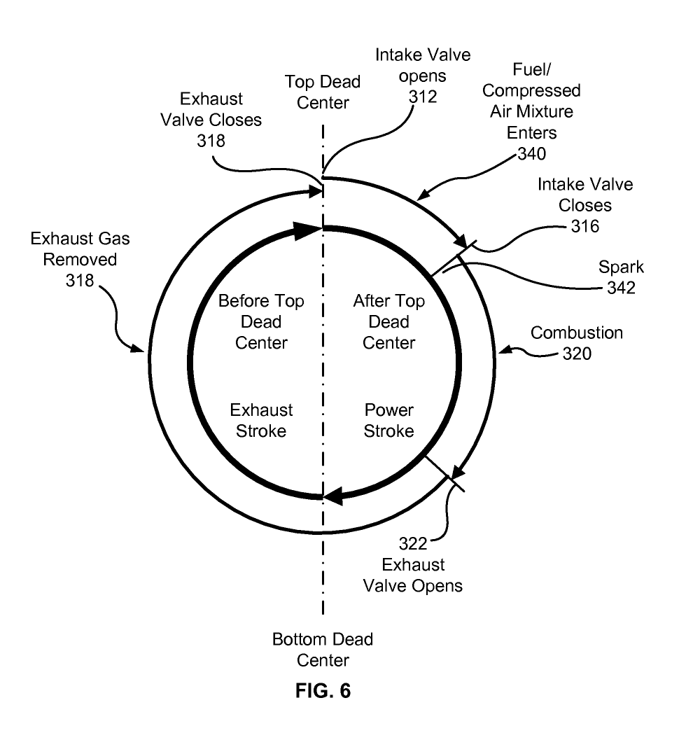

FIG. 6 is a cycle diagram illustrating various alternative phases of an embodiment of the internal combustion engine 120 of FIG. 1 and the block diagrams of FIG. 2A-2E in accordance with aspects of the technology. FIG. 6 differs from FIG. 3 in that a fuel and compressed gas mixture enters the cylinder 122 when the intake valve opens at time 312 and a spark ignites the fuel air mixture at time 342.

FIG. 7 is a cycle diagram illustrating various phases of an embodiment of the internal combustion engine 120 of FIG. 1 operating in a reverse direction in accordance with aspects of the technology. FIG. 7 differs from FIG. 3 in that the internal combustion engine is being operated in reverse and the crankshaft 210 is turning in a reverse direction instead of the forward direction. The reverse direction in FIG. 7 is counter-clockwise around the cycle diagram. Thus, period 314 during which the compressed gas enters the cylinder 122 occurs during the before top dead center portion of the cycle diagram. The intake valve closes at a time 316 which is also before top dead center. The fuel is injected during time period 318. Thus, the combustion during time period 320 drives the piston 124 in a reverse direction through the power stroke toward bottom dead center. The exhaust gas 238 is removed during period 324 during the exhaust stroke. At least a portion of the exhaust stroke occurs before top dead center. The timing diagrams in FIGS. 4-6 may similarly be reversed to illustrate a reverse rotation of the internal combustion engine 120.

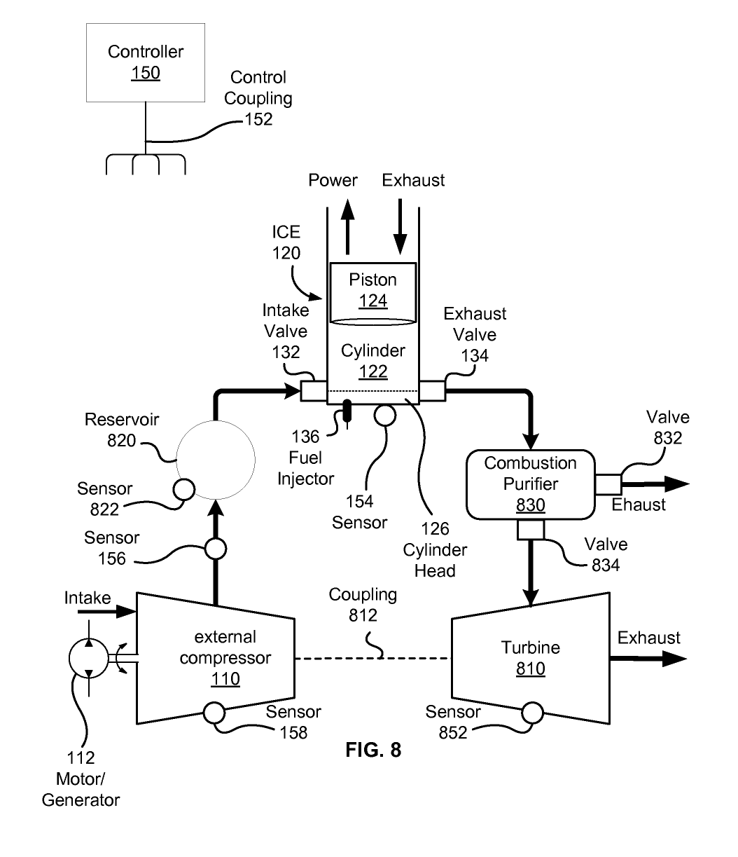

FIG. 8 is a block diagram illustrating an alternative embodiment of the internal combustion engine 120 of FIG. 1. FIG. 8 differs from FIG. 1 in that in FIG. 8 includes a reservoir 820 and a turbine 810. The turbine 810 is configured to receive exhaust gas 238 from the internal combustion engine 120 and drive the external compressor 110 using energy from the exhaust gas 238. The turbine 810 may be coupled to the internal combustion engine 120 via an optional combustion purifier 830. Alternatively, the turbine 810 is coupled directly to the internal combustion engine 120. Valves 832 and 834 may be used to direct exhaust gas 238 to the turbine 810 or to bypass the turbine. For example, valve 832 may direct exhaust gas 238 to a parallel turbine or to atmosphere. Exhaust gas from the turbine may be coupled to another turbine (not shown), to another combustion purifier (not shown), or directly to atmosphere. The controller 150 may be coupled to valves 832 and 834 via a control coupling 152 and configured to control opening and closing of these valves. In some embodiments, the turbine 810 receives compressed gas and/or fuel from sources other than, or in addition to the internal combustion engine 120.

The turbine 810 is coupled to the external compressor 110 via a coupling 812. In various embodiments, the coupling 812 includes a drive shaft, a generator, a transmission, etc. A sensor 852 may be coupled to the turbine 810 and configured to provide data to the controller 150. The sensor 852 includes one or more sensors configured to sense various parameters of the turbine 810 including a pressure, temperature, volume, flow, RPM, torque, and/or the like. The controller 150 may be coupled to the sensor 852 via a control coupling 152 and configured to receive data from the sensor 852.

The reservoir 820 is configured to receive compressed gas 230 from the external compressor 110 and store the compressed gas. The reservoir 820 is further configured to provide a constant supply of the compressed gas 230 to the internal combustion engine 120 at a desired pressure and temperature. When the reservoir 820 is large compared to the total volume of the cylinder 122, the pressure of the compressed gas 230 may be relatively unaffected by pulsation of discontinuous charging of the cylinder 122. A sensor 822 may be coupled to the reservoir 820 and configured to provide data to the controller 150. The sensor 822 includes one or more sensors configured to sense various parameters of the reservoir 820 including a pressure, temperature, volume, flow, RPM, torque, and/or the like. In some embodiments, the reservoir 820 may be insulated to maintain the temperature of the reservoir 820. Further, a heater (not shown) may be disposed in or around the reservoir to heat the compressed gas 230 and/or to add heat or make-up heat, e.g., heat lost during storage.

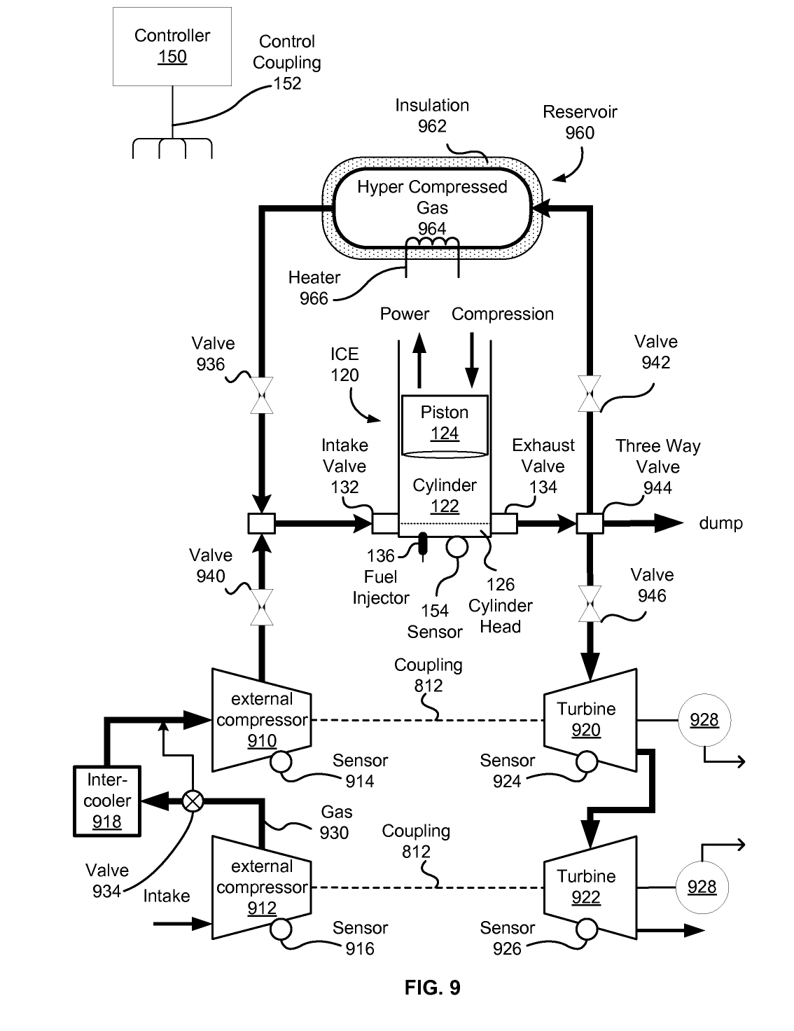

FIG. 9 is block diagram illustrating an alternative embodiment of the internal combustion engine 120 of FIG. 8. FIG. 9 differs from FIG. 8 in that FIG. 9 includes two external compressors and turbines instead of a single stage compressor and turbine. FIG. 9 further differs in that the reservoir 820 of FIG. 8 is omitted and a reservoir 960 is disposed in parallel with the internal combustion engine 120. External compressors 910 and 912 are arranged in a two stage configuration. External compressor 912 is configured to compress ambient air and provide the pre-compressed gas 930 to external compressor 910. External compressor 910 is configured to further compress the gas 930 and provide the compressed gas 230 to the internal combustion engine 120. In some embodiments, the gas 930 may be cooled using intercooler 918. A bypass valve 934 may route the gas 930 directly to external compressor 910.

Turbines 920 and 922 are arranged in a two stage configuration. Turbine 920 may receive exhaust gas 238 and extract energy from the exhaust gas 238 to drive the external compressor 910. Turbine 922 may receive the exhaust gas 238 at a reduced pressure from turbine 920 and extract additional energy from the exhaust gas 238. Turbine 920 is configured to drive external compressor 910 and turbine 922 is configured to drive external compressor 912 using couplings 812. Optional energy storage 928 may be coupled to the turbines 920 and 922. In various embodiments, the energy storage 928 includes generators and batteries, flywheels, etc.

The controller 150 may be coupled to the external compressors 910 and 912 and the turbines 920 and 922 via control coupling 152 and configured to control these devices as described elsewhere here. The controller 150 may be coupled to a sensor 914 and 916 via coupling 152. The sensors 914 and 916 each include one or more sensors configured to sense various parameters of the external compressor 910 and 912 respectively including an RPM temperature, pressure, volume, flow, and/or the like. Sensors 925 and 926 may be coupled to turbines 920 and 922 respectively and configured to provide data to the controller 150 via the control coupling 152. The sensor 924 and 926 include one or more sensors configured to sense various parameters of the turbine 920 and 922 respectively including a pressure, temperature, volume, flow, RPM, torque, and/or the like. While a two stage compressor system is illustrated in FIG. 9, more than two stages may be used to provide compressed gas 230 to the internal combustion engine 120. While a two stage turbine system is illustrated in FIG. 9, more than two stages may be used to extract energy from exhaust gas 238.

The reservoir 960 is configured to receive hyper-compressed gas 964 from the internal combustion engine 120 and store the gas at a high temperature. For example, the intake valve 132 may admit compressed gas 230 into the cylinder 122 during the power stroke and close when the piston 124 is at bottom dead center. During the exhaust stroke, with both the intake valve 132 and the exhaust valve 134 closed, the piston 124 may further compress the compressed gas 230 to produce hyper-compressed gas 964. At top dead center the exhaust valve 134 may be opened to output the hyper-compressed gas 964 via a three-way valve 944 to the reservoir 960. A valve 942 may further be used as a one-way valve and/or for maintaining storage of the hyper-compressed gas 964 in the reservoir 960. The reservoir 960 may include insulation 962 configured to conserve heat. The reservoir 960 may further include a heater 966 disposed in or around the reservoir 960 to make up heat loss during storage or further increase the temperature of the stored gas.

The reservoir 960 may provide compressed gas 230 from the stored hyper-compressed gas 964 via three-way valve 938. Valve 936 may be used for pressure reduction. In some embodiments, hyper-compressed gas 964 stored in the reservoir 960 may be used for driving the turbine 920 and may be directed to the turbine 920 via the three way valve 944. In some embodiments, the hyper-compressed gas 964 may be directed from the internal combustion engine 120 via the exhaust valve 134 and the three way valve 944 to the turbine 920.

In some embodiments, the internal combustion engine 120 may be used as a brake by pumping braking energy into the reservoir 960 in the form of hyper-compressed gas 964. The pumped gas may serve to reduce the RPMs of the internal combustion engine 120. An amount of braking may be controlled using the intake valve 132 to control a volume of compressed gas 230 admitted to the cylinder 122 for each cycle of the internal combustion engine 120. The amount of braking may be further controlled using the exhaust valve 134 to control output pressure of the hyper-compressed gas 964 to the reservoir 960. Thus, braking may be exerted over a wide range. For example, compressed gas 230 at 8 times ambient may be admitted to the cylinder 122 when the piston 124 is at bottom dead center. The compressed gas 230 may be further compressed by a factor of 8 to produce hyper-compressed gas 964 at 64 times ambient. In another example, the compressed gas 230 may be admitted to half the volume of the cylinder by closing the intake valve 132 when the piston 124 is at 90 degrees before top dead center and released when the compression ration ratio reaches 2:1 to produce hyper-compressed gas 964 at 16 times ambient. Thus, the external compressor 910 and the compressed gas 230 may be used to multiply the braking power of the internal combustion engine 120 over a wide range. Moreover, the reservoir 960 may be used to conserve the braking energy instead of dumping compressed gas to ambient.

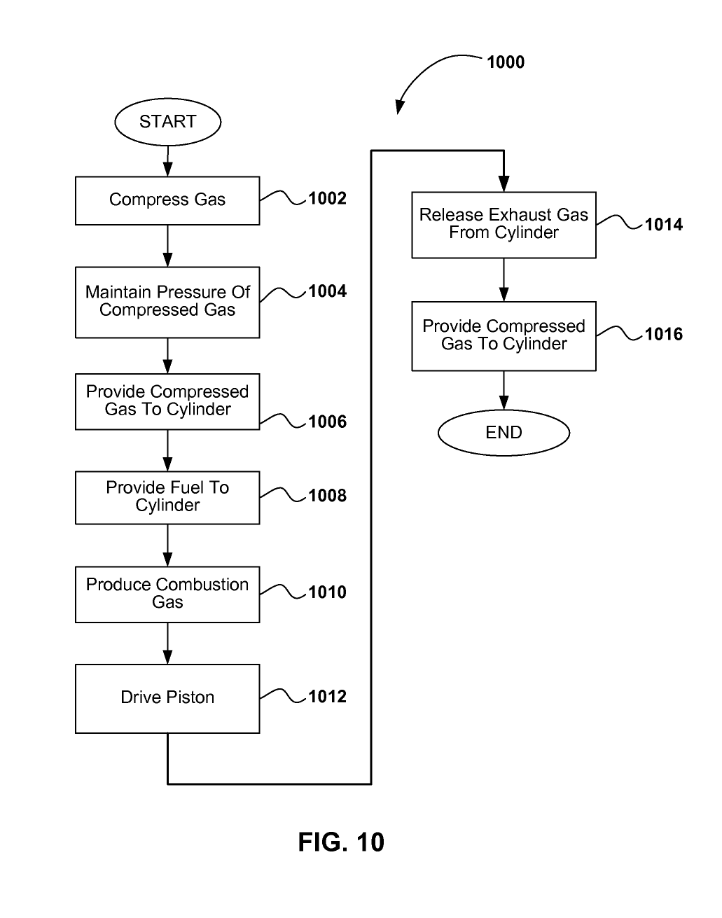

FIG. 10 is a flow diagram of an exemplary process 1000 for operating an internal combustion engine. In step 1002 a gas is compressed outside of an internal combustion engine. In various embodiments, the gas may be compressed to some pressure greater than 4, 8, 12, 16, 17, 18, 20, 25, 30, 40, or 50 times ambient pressure, as desired. In step 1004 the pressure of the compressed gas is maintained continuously at a pressure greater than a desired pressure for at least four strokes of the internal combustion engine. For example, the pressure may be maintained continuously above the desired pressure using a compressed gas source capable of providing a large volume of gas. In some embodiments, a reservoir many times a volume of a cylinder of the internal combustion engine may hold the compressed gas.

In step 1006, the compressed gas is provided to a cylinder of the internal combustion engine after a piston in the cylinder has passed top dead center during a power stroke. The compressed gas may also be provided to the cylinder before top dead center and as the piston passes top dead center. In step 1008 fuel is provided to the cylinder before the piston reaches bottom dead center during the power stroke. In some embodiments, fuel is injected into the cylinder after the compressed gas is provided. Alternatively, fuel is provided with the gas as a fuel/air mixture.

In step 1010 combustion gas is produced during the power stroke from the mixture of the fuel and compressed gas in the cylinder. Combustion may be initiated using a spark. Alternatively, combustion may occur spontaneously when the temperature of the compressed gas is equal to or greater than an auto ignition temperature of the gas. Thus, the fuel and compressed gas are provided to the cylinder and the combustion gas is produced during the same power stroke. In step 1012, the combustion gas drives the piston toward bottom dead center during the power stroke.

In step 1014, exhaust gas is released from the cylinder during the exhaust stroke that immediately follows the power stroke. That is, there is no intervening power stroke. A portion of the exhaust gas may also be released during a portion of the power stroke. Thus, the combustion gas may not drive the piston all the way to bottom dead center and the exhaust gas release may begin before reaching bottom dead center. In step 1016, compressed gas is provided to the cylinder during a power stroke immediately following the exhaust stroke. While a single cylinder is described for the process 1000, the internal combustion engine may include more than one cylinder and each cylinder may be out of phase with other cylinders. Although the process 1000 for operating an internal combustion engine is described as being comprised of various components, fewer or more components may comprise operating an internal combustion engine and still fall within the scope of various embodiments.

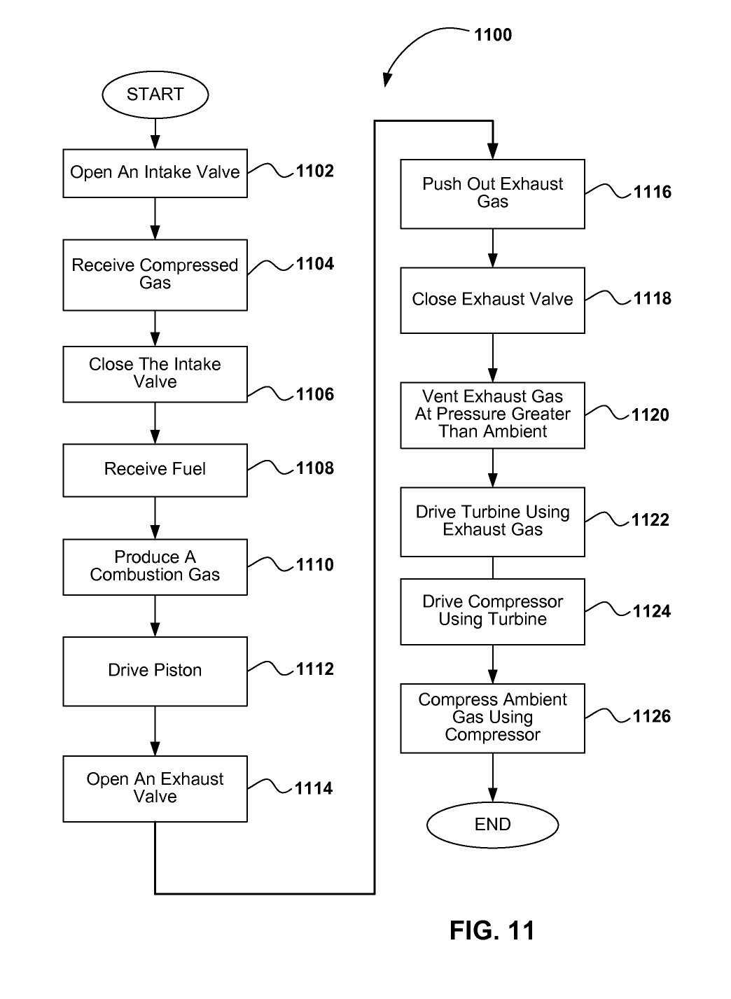

FIG. 11 is a flow diagram of an exemplary process for operating an internal combustion engine. In step 1102, an intake valve of a cylinder in an internal combustion engine is opened. The intake valve may be opened before or after a piston in the cylinder passes top dead center. In step 1104, compressed gas is received by the cylinder from outside the internal combustion engine via the open intake valve. The compressed gas is received at or above a combustion temperature of a fuel. In some embodiments, the compressed gas is received at or above an auto ignition temperature of the fuel. In step 1106, the intake valve is closed after the piston passes top dead center of a power stroke. In step 1108, fuel is received before the piston reaches bottom dead center of the power stroke. In some embodiments, fuel may be received from a fuel injector after the intake valve closes. Alternatively, the fuel may be received during at least a portion of the time that the compressed gas is received. For example, the fuel and compressed gas may be received by the cylinder in the form of a fuel/air mixture. In step 1110 a combustion gas is produced from the compressed gas and the fuel. In some embodiments, a spark is used to initiate combustion. Alternatively, auto ignition of the fuel and compressed gas mixture initiates combustion. In steps 1106-1110, the intake valve is closed, the fuel and compressed gas are received, and the combustion product is produced all in the same power stroke.

In step 1112 the piston is driven toward bottom using the combustion gas. In step 1114, the exhaust valve is opened. The exhaust valve may be opened before, at, or after reaching bottom dead center. In step 1116 exhaust gas is pushed out of the cylinder via the exhaust valve. The piston is used during an exhaust stroke to push the exhaust gas out of the piston. There is no intermediate intake stroke between the power stroke and the exhaust stroke. In step 1118, the exhaust valve is closed. The exhaust valve may be closed before or after opening the intake valve for the next power stroke.

In step 1120, the exhaust gas is vented at a pressure greater than the ambient. The timing for opening the exhaust valve in step 1114 may be selected for a pressure of the exhaust gas greater than the compressed gas. In step 1122, a turbine is driven using the vented exhaust gas. In step 1124, the turbine is used to drive a compressor. In step 1126, the compressor is used to compress ambient gas and produce the compressed gas.

Several embodiments are specifically illustrated and/or described herein. However, it will be appreciated that modifications and variations are covered by the above teachings and within the scope of the appended claims without departing from the spirit and intended scope thereof. For example, an intercooler may be disposed between the reservoir 960 and the internal combustion engine 120. For example, any combustible fuel may be used in an engine. For example, waste products may be powdered and used in an engine. For example, multiple controllers may be employed to control various aspects of an internal combustion engine including valves, actuators, sensors, etc. Various embodiments of the technology include logic stored on computer readable media (e.g., the controller 150), the logic configured to perform methods of the invention.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a compressor configured to increase a pressure and temperature of a gas, to maintain a continuous pressure of a compressed gas at more than four times ambient pressure, and to maintain a continuous temperature of the compressed gas at greater than a combustion temperature of a fuel;
an internal combustion engine including,
a cylinder configured to receive the compressed gas from the compressor at the increased pressure and temperature,
a piston disposed in the cylinder, and
an intake valve disposed between the compressor and the cylinder, the intake valve configured to open based on a position of the piston for admitting the compressed gas into the cylinder; and
a fuel source configured to provide the fuel to the cylinder.

2. The system of claim 1, further comprising a reservoir configured to receive the compressed gas from the compressor and provide the compressed gas to the intake valve.

3. The system of claim 1, further comprising a reservoir configured to receive a hyper-compressed gas from the internal combustion engine, the hyper-compressed gas including compressed gas that has been compressed by the internal combustion engine to a pressure greater than the pressure of the compressed gas.

4. The system of claim 1, further comprising a heater configured to heat the compressed gas outside the internal combustion engine.

5. The system of claim 1, wherein the compressor is further configured to maintain the pressure of the gas at more than four time ambient pressure for more than four cycles of the internal combustion engine.

6. The system of claim 1, wherein the compressor is further configured to maintain the temperature of the compressed gas at greater than the combustion temperature of a fuel for more than four cycles.

7. The system of claim 1, further comprising a turbine coupled to the compressor, the turbine configured to receive an exhaust gas from the cylinder and to drive the compressor using the exhaust gas.

8. The system of claim 1, further comprising a controller configured to control a closing of the intake valve and a closing of an exhaust valve based on a position of the piston.

9. The system of claim 8, wherein the controller is further configured to open the intake valve after each time the piston passes top dead center.

10. The system of claim 8, wherein the controller is further configured to close the intake valve after the piston passes 80 degrees after top dead center.

11. The system of claim 8, wherein the controller is further configured to control a timing and sequence of the intake valve, an exhaust valve, and the fuel source to operate the internal combustion engine at less than 30 rotations per minute.

12. The system of claim 8, wherein the controller is further configured to control a timing and sequence of the intake valve, an exhaust valve, and the fuel source to operate the internal combustion engine in a reverse rotation.

13. The system of claim 8, wherein the controller includes a computer processor and the intake valve includes a hydraulic actuator.

14. The system of claim 8, wherein the controller is further configured open the intake valve and an exhaust valve before the piston reaches top dead center, close the intake valve after closing the exhaust valve and after the piston passes top dead center, and provide the fuel to the cylinder after closing the intake valve and before reaching bottom dead center.

15. The system of claim 8, wherein the controller is further configured to control a timing of the fuel source to provide fuel to the cylinder after each time the piston passes top dead center.

16. The system of claim 8, wherein the controller is further configured to open an exhaust valve while a pressure of an exhaust gas in the cylinder is greater than approximately four times atmospheric pressure.

17. The system of claim 1, wherein the fuel source comprises a fuel injector configured to inject fuel into the cylinder.

18. The system of claim 1, wherein the compressor is configured to increase the pressure of the gas to more than 8, 10, 16, 17, 20, 25, 30, 35, 40, or 50 times ambient pressure.

19. The system of claim 1, wherein the compressor is configured to increase a pressure of the gas and a temperature and of the gas to more than an auto ignition temperature of the gas.

20. The method of claim 1, wherein the fuel includes vehicle tire dust.

21. A method comprising:
compressing a gas outside of an internal combustion engine;
maintaining a pressure of the compressed gas continuously greater than four times ambient pressure during more than four strokes of the internal combustion engine;
providing compressed gas to a cylinder of the internal combustion engine after a piston in the cylinder passes top dead center during a power stroke;
providing a fuel to the cylinder before the piston reaches bottom dead center during the power stroke;
producing a combustion gas in the cylinder from the compressed gas and the fuel during the power stroke;
driving the piston in the cylinder using the combustion gas during the power stroke;
releasing an exhaust gas from the cylinder during an exhaust stroke immediately following the power stroke; and
providing the compressed gas to the cylinder after the piston passes top dead center during a power stroke immediately following the exhaust stroke.

22. The method of claim 21, wherein producing the combustion gas comprises igniting a mixture of the fuel and the compressed gas using a spark.

23. The method of claim 21, wherein the pressure of the compressed gas is greater than eight times ambient pressure.

24. The method of claim 21, wherein the pressure of the compressed gas is greater than ten times ambient pressure.

25. The method of claim 21, further comprising providing compressed gas to the cylinder before top dead center of the power stroke.

26. The method of claim 25, further comprising releasing exhaust gas while receiving compressed before top dead center of the power stroke.

27. The method of claim 21, further comprising
releasing the exhaust gas at a pressure of greater than four times the ambient pressure;
driving a turbine using the released exhaust gas;
driving a compressor using the turbine; and
compressing the gas using the compressor.

28. The method of claim 21, further comprising storing the compressed gas in a reservoir and heating the stored compressed gas.

29. The method of claim 21, further comprising maintaining a temperature of the compressed gas continuously greater than a combustion temperature of the fuel during more than four strokes of the internal combustion engine.

30. The method of claim 21, further comprising maintaining a temperature of the compressed gas continuously greater than an auto combustion temperature of the fuel during more than four strokes of the internal combustion engine.

31. The method of claim 21, wherein the fuel is paraffin, coal dust, flour, paint, saw dust, rice dust, grain dust, cellulose dust, or vehicle tire dust.

32. A method comprising:
opening an intake valve of a cylinder of an internal combustion engine;
receiving a compressed gas having a temperature of a fuel combustion temperature, the compressed gas received through the open the intake valve from outside of the internal combustion engine;
closing the intake valve after a piston in the cylinder passes top dead center of a power stroke;
receiving the fuel before the piston reaches bottom dead center of the power stroke;
producing a combustion gas in the cylinder from the fuel and the compressed gas before the piston reaches bottom dead center of the power stroke;
driving the piston in the cylinder using the combustion gas;
opening an exhaust valve;
pushing an exhaust gas out of the cylinder through the open exhaust valve using the piston during an exhaust stroke immediately following the power stroke; and
closing the exhaust valve before reaching top dead center of the exhaust stroke.

33. The method of claim 32, wherein the compressed gas is at a pressure greater than four atmospheres.

34. The method of claim 32, further comprising closing the exhaust valve after opening the intake valve to purge exhaust gas from the cylinder.

35. The method of claim 32, further comprising opening the intake valve after top dead center of the power stroke.

36. The method of claim 32, further comprising opening the exhaust valve before bottom dead center of the power stroke.

37. The method of claim 32, wherein the temperature of the received compressed gas is greater than an auto ignition temperature.

38. The method of claim 32, further comprising heating the vented exhaust gas.

39. The method of claim 32, further comprising:
venting the exhaust gas at a pressure of greater than ambient pressure;
driving a turbine using the vented exhaust gas;
driving a compressor using the turbine; and
compressing ambient gas to produce the compressed gas using the compressor.

40. The method of claim 39, wherein the pressure of the vented exhaust gas is greater than the compressed gas.

41. The method of claim 39, further comprising heating the compressed gas before receiving the compressed gas.

42. The method of claim 32, wherein the fuel includes paint.
